(19) United States
(12) Patent Application Publication
(10) Pub. No.: US 2005/0054316 A1
(43) Pub. Date: Mar. 10, 2005

(54) Method for providing clock signals to transceiver chip and transceiver chip

(76) Inventors: Dominicus Martinus Wilhelmus Leenaerts, Eindhoven (NL); Kathleen Jeanne Petrus Philips, Eindhoven (NL); Hendrik Johannes Bergveld, Eindhoven (NL); Eric Jurgen Van Der Zwan, Valkenswaard (NL); Josephus Antonius Huisken, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/500,759

(22) PCT Filed: Dec. 9, 2002
(86) PCT No.: PCT/IB02/05370

(30) Foreign Application Priority Data
Jan. 11, 2002 (EP) 02075094.9

(51) Int. Cl. H04B 1/16; H04B 1/06; H04B 7/00

(52) U.S. Cl. 455/255; 455/208

(57) ABSTRACT

In a method of the invention for providing clock signals to a mixed signal telecommunication chip having a communication signal in a communication signal band, said clock signals comprise a central clock frequency signal and sub-frequency signals which are multiples or divisions of said central clock frequency signal. The central clock frequency signal is selected such that the central clock frequency signal and the sub-frequency signals are located outside the telecommunication signal band. The a mixed signal telecommunication chip of the invention takes advantage of the above clock planning.

The invention relates to a method for providing clock signals to a mixed signal telecommunication chip and a mixed signal telecommunication chip.

When radio frequency (RF) is placed together with analog and digital signals on a single chip clock, planning becomes essential. Very often in digital systems multiple clocks are used with a non integer ratio between each other. An a-synchronous logic is also used quite often. The odd multiples of the clock frequencies and/or the cross modulation products between the frequencies can be found far within the RF range and may corrupt the information signal due to substrate bounce. These substrate bounce effects exist because the current spikes due to the clock operations are injected as voltage noise into the substrate via the bond wires or via the pn-junctions in the MOS devices. The substrate easily picks up the clock frequency and multiples of this clock frequency can, therefore, be found on the substrate. This substrate is shared by the sensitive RF circuits which will pick up these signals and FM modulation might occur, thereby disturbing the communication signals processed by the circuit.

It is the object of the present invention to find a solution for the above problems with the disturbance of the communication signals by the clock signals on a mixed signal telecommunication chip.

According to an aspect of the invention, a method for providing clock signals to a mixed signal telecommunication chip having a communication signal in a communication signal band, said clock signals comprising a central clock frequency signal and sub-frequency signals which are multiples or divisions of said central clock frequency signal, is provided wherein the central clock frequency signal is selected such that the central clock frequency signal and the sub-frequency signals are located outside the telecommunication signal band. This aspect of the invention solves the problem thereby that the central clock frequency itself and the sub frequencies thereof are not falling into the telecommunication signal band. The present invention can use only a single clock, and all other clock frequencies are integer multiples or integer divisions from the central clock. In the invention, the clock planing in the mixed signal communication chip is an important and advantageous way to prevent distortion of the communication signals processed by the circuit.

According to a preferred aspect of the method of the invention, the telecommunication signal band is between 2,402 GHz and 2,480 GHz which is the telecommunication signal band of the Bluetooth® application. Bluetooth® is the preferred application of the present invention.

According to a preferred aspect of the method of the invention, the central clock frequency is a multiple of 2. This central clock frequency is advantageous because multiples of 2 can be easily handled by logic.

According to a preferred aspect of the method of the invention, the central clock frequency is in between 70 MHz and 90 MHz, preferably 64 MHz, 76 MHz, 78 MHz or 80 MHz. For Bluetooth® which operates in the 2.402-2.480 GHz band, this clock planning leads to interesting clock frequencies because odd multiples of clock frequencies like 76 MHz, 78 MHz, 80 MHz are not falling into the Bluetooth® band.

According to a preferred aspect of the method of the invention, the central clock frequency is 64 MHz, the precision is 8 bit and the over-sampling factor is 32. The required precision for the analog to digital converter 4 are eight bit. In order to have a better demodulation, over-sampling can be used and a factor of eight is advantageous in this respect. This is another aspect why the 64 MHz clock frequency is a preferred clock frequency.

According to a preferred aspect of the method of the invention, the chip comprising functional circuit blocks, wherein the central-clock-frequency is supplied to the functional blocks by an on-chip oscillator. The on chip oscillator is connected to a separate external crystal oscillator. This external crystal oscillator is separated from the chip. This oscillator creates the central clock frequency of 64 MHz.

According to an aspect of the invention, there is provided a mixed signal telecommunication chip comprising as functional blocks a RF front end portion, an analog to digital converter, a demodulator/modulator, a digital to analog converter, an oscillator and a RF synthesizer for processing a communication signal in a communication signal band, wherein the functional blocks are fed by clock signals comprising a central clock frequency signal and sub-frequency signals which are multiples or divisions of said central clock frequency signal, and wherein the central clock frequency signal and the sub-frequency signals are located outside of the telecommunication signal band. This results in an advantageous telecommunication chip in which the clock planing serves to prevent distortion of the communication signals processed by the circuit.

According to a preferred aspect of the chip of the invention, the telecommunication signal band is between 2,402 GHz and 2,480 GHz.

According to a preferred aspect of the chip, the central clock frequency is a multiple of 2.

According to a preferred aspect of the chip of the invention, the central clock frequency is in between 70 MHz and 90 MHz, preferably 64 MHz, 76 MHz 78 MHz or 80 MHz.

According to a preferred aspect of the chip of the invention, the central clock frequency is 64 MHz, the precision is 8 bit and the oversampling factor is 32.

According to a preferred aspect of the chip of the invention, the digital to analog converter is directly connected to the RF front end portion. When a digital to analog converter is used which is oversampled at 64 MHz, the sinc operation due to oversampling will spread out and attenuate the spectrum of the analog signal at the output of the digital to analog converter. For Bluetooth® specifications the digital to analog converter can be directly connected to the RF front and portion.

According to a preferred aspect of the chip of the invention, the chip comprises an on-chip-oscillator supplying the central clock frequency to the functional blocks.

According to a preferred aspect of the chip of the invention, the on-chip oscillator is connected to an external oscillator.

According to a preferred aspect of the chip of the invention, the external oscillator is a crystal oscillator.

Preferreed embodiments of the invention are now described with reference to the drawings in which:

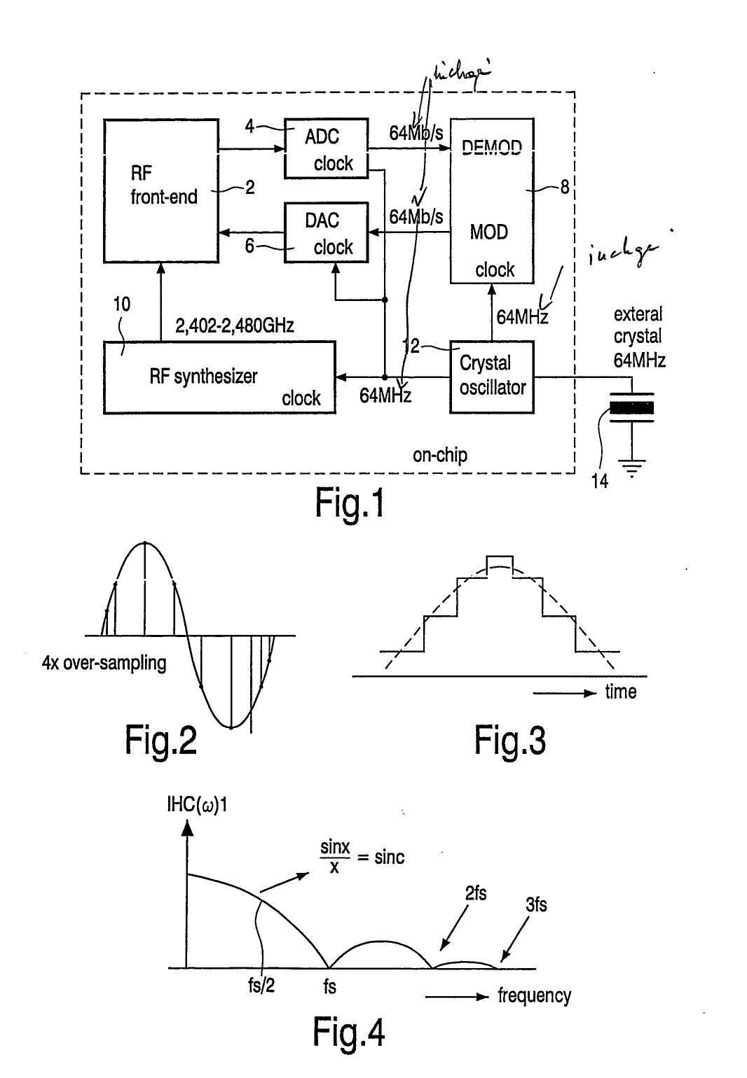

FIG. 1 is a drawing, which shows functional components which are on chip and the connections between the functional components and the connection from the on-chip oscillator to the external oscillator;

FIG. 2 is a drawing which shows the 4×oversampling of an analog signal. The oversampling is done by the analog to digital converter 4;

FIG. 3 is a hold function in time domain of the digital to analog converter 6;

FIG. 4 is the Fourier transformation of the hold function in time domain of FIG. 3 to frequency domain;

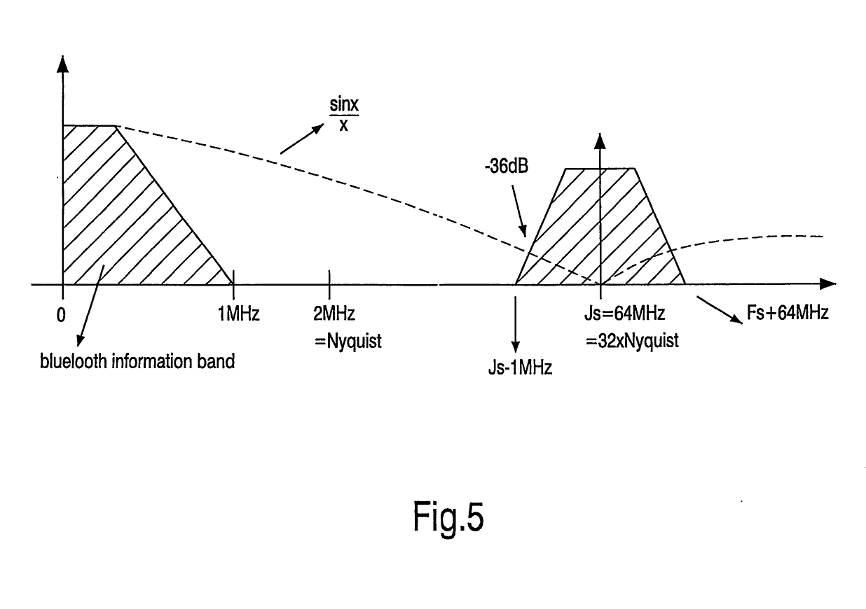

FIG. 5 shows the frequency spectrum for Bluetooth®. The sampling frequency is 64 MHz;

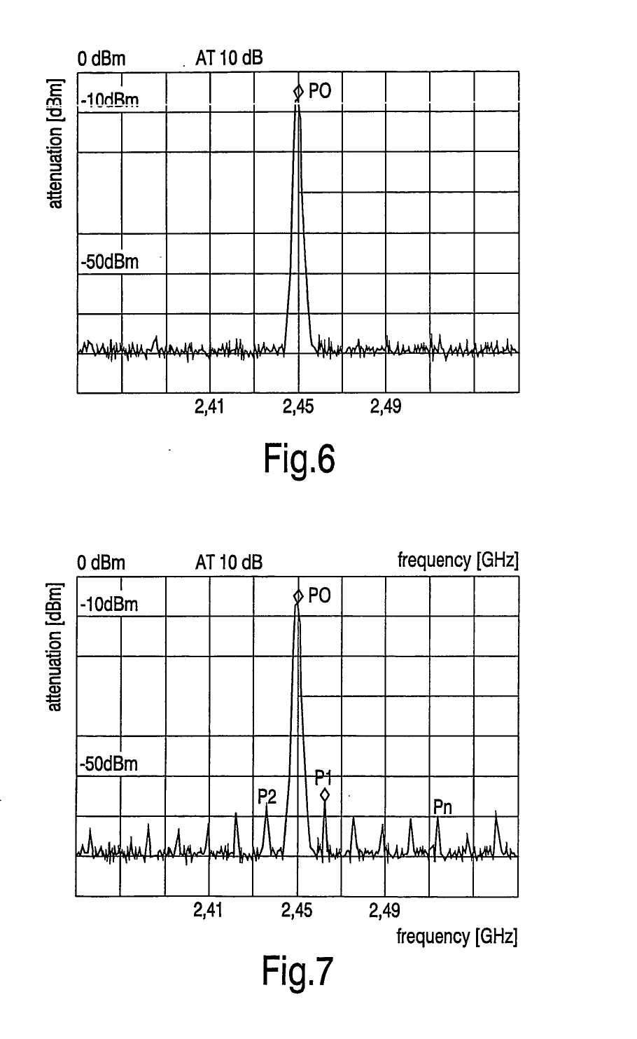

FIG. 6 shows the spectrum of the telecommunication signal band when no digital circuitry is active;

FIG. 7 shows the output spectrum of the telecommunication signal band when the digital circuitry is active; and

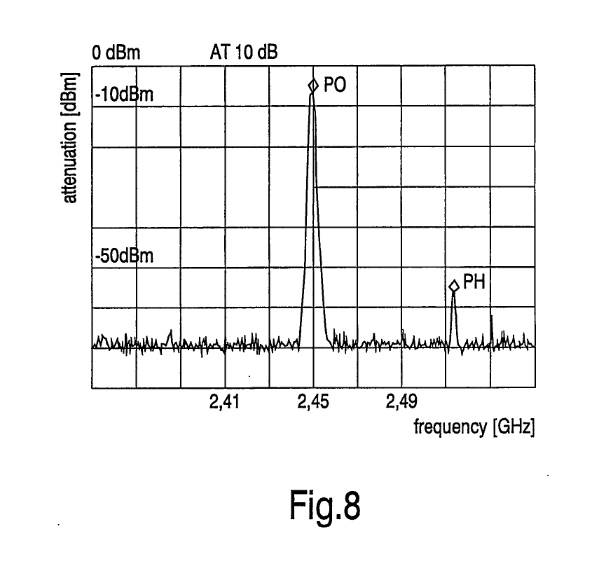

FIG. 8 shows the spectrum when 64 MHz clock has been used. The spurious tone falls outside the spectrum of Bluetooth®.

FIG. 1 shows the components of the chip and the external crystal oscillator 12. The functional components on the chip are the RF front end unit 2, analog to digital converter 4, digital to analog converter 6, modulator/demodulator 8, RF synthesizer 10, the crystal oscillator 12 and the external oscillator 14. The RF synthesizer 10, the digital to analog converter 6, the analog to digital converter 4 and the modulator/demodulator 8 are connected to the crystal oscillator 12. The crystal oscillator 12 supplies the central clock frequency of 64 MHz. The RF synthesizer 10 is connected to the RF front end. The synthesizer synthesize clock frequencies between 2,402-2,480 GHz needed for up/down conversion of the Bluetooth® band. Therefore, in this case a single frequency is used. The RF front end unit 2 is connected to the analog to digital converter 4.

In the case when a signal is to be received, the RF front end unit 2 sends the analog received signal to the analog to digital converter 4 to convert the analog signal into a digital signal. The converted signal is send from the analog to digital converter 4 to the demodulator 8. The demodulator 8 demodulates the signal for the further operations. That is the way of the signal when it is received.

In the case when a signal is to be transmitted, a signal is first modulated by the modulator. After the modulation a digital signal is send from the modulator 8 to the digital to analog converter 6. The digital to analog converter 6 convert the digital signal to an analog signal. The digital to analog converter 6 receive the signal from the modulator by a data rate of 64 Mbit/s. The converted signal is send from the digital to analog converter 6 to the RF front end unit 2.

The Bluetooth® data rate is 1 Mbit/s. For a good sample detection, 8 bits per sample are needed. This results in a data rate of 8 Mbit/s at the output of the analog to digital converter 4. FIG. 2 shows a drawing of a sinus curve which is four times over-sampled to get better precision. Besides the over-sampling the signal-to-noise-ratio increases also. In order to have better demodulation, over-sampling can be used by a factor of 8 which shows suitable results. The data rate will then be 64 Mbit/s. The clock frequency is 64 MHz. On the left side of FIG. 2, the minimum required sample frequency is shown. The sample frequency is at Nyquist rate. The sample frequency at Nyquist rate is equal to two times of the maximum signal frequency.

A digital to analog converter 6 has a hold function in time domain which is shown in FIG. 3. The Fourier transformation of the hold function in time domain to the frequency domain is shown in FIG. 4. There is shown a sinc function which has a filter behavior, especially for frequencies beyond fs/2. fs designates the sampling frequency.

In order to achieve for example 36 dB attenuation at 8 MHz there are two options. The first option is to use an over-sampled digital to analog converter 6 and a second order filter. The digital to analog converter 6 is four times over-sampled. The sampling frequency is 8 MHz. The attenuation is 18 dB superior for a 1 MHz signal at 8 MHz. The filter gives an additional attenuation of 36 dB, hence the resulting attenuation is 54 dB. The alternative to the second order filter is a first order filter which provides 18 dB attenuation thus the attenuation is about 36 dB.

The second option and the preferred possibility is a highly over-sampled digital to analog converter 6. If the signal is 32 times over-sampled, than the sampling frequency is equal to 64 MHz and the attenuation is 36 dB. This version has the advantage that no filter is needed and therefore, the design is simplified.

The spectrum of Bluetooth® is shown in FIG. 5. In FIG. 5, the information band of Bluetooth® is in the range from 0 Hz to 1 MHz. The Nyquist frequency is 2 MHz. According to the sinc function (FIG. 5) the next upper side band on the right side of the Bluetooth® information band is attenuated with −36 dB. The sample frequency in the FIG. 5 is 64 MHz which means that the sampling frequency is 32 times the Nyquist frequency.

The next upper band of the Bluetooth® information band is around the sampling frequency of 64 MHz. The information band ranges here from 63 MD to 65 MHz. Because of the over-sampling, the digital to analog converter 6 can directly be connected to the RF front end when it is over-sampled by a factor of 32.

Another advantage of the over-sampling of the digital to analog converter 6 is the power saving. Power can be saved because of the direct connection of the digital to analog converter 6 to the RF front end. There are no other devices in between which should be supplied with energy.

Another reason why 64 MHz is a preferred and advantageous central clock frequency for Bluetooth® standard is the fact that 64 MHz divided by 128 (a multiple of 2) results in 500 kHz which is a clock frequency to be used in the phase locked loop to center the oscillators.

By choosing one specific clock frequency or clock planning, respectively, separate filter operations or filter means are not necessary anymore because a filter action is implicitly obtained due to the precise over-sampling and, furthermore, no interfering clock signals are present in the band of operation. FIG. 6 shows the spectrum when no digital circuitry is active. The center frequency is 2.45 GHz where the attenuation of peak P 0 is −5.05 dBm and no disturbing frequencies can be seen.

FIG. 7 shows the output spectrum of the telecommunication signal band when the digital circuitry is active. A 13 MHz clock signal is used in the digital circuit. It can be seen that the center frequency is 2.45 GHz where the attenuation of peak P 0 is −5.05 dBm and the multiples P 1 . . . P n of the 13 MHz clock signal appear around the center frequency in the signal band. It can be seen that peak P 1 has an attenuation of −50.66 dBm which is significantly above the noise level of approximately −70 dBm. Therefore the harmonic frequencies tend to disturb the communication signals.

The multiples of the clock do not fall into the spectrum of the telecommunication signal when 64 MHz is used as clock frequency. This effect is shown in FIG. 8. Here again, the center frequency is 2.45 GHz where the attenuation of peak P 0 is −5.05 dBm. The integer multiples of this central clock frequency do not appear in the frequency band of the telecommunication signal. The harmonic frequencies can be calculated by multiplying the central clock frequency with integer factors. The shown harmonic frequency PH of the clock frequency of 64 MHz is approximately 110 MHz higher than the signal frequency of 2.45 GHz. In view of this frequency distance there is no disturbance of the signal frequency by harmonics of the central clock frequency.

Moreover, the choice of 64 MHz central clock frequency in combination with 8 bit precision and the demand for a specific signal to noise ratio leads to 8 time over-sampling of the analog to digital converter 4 in the receiver portion. The over-sampling by 32 times in the transmit chain for the digital to analog converter 6 results in saving of additional filtering, hence power saving. The clock frequency 64 MHz divided by 128 (a multiple of 2) gives 500 kHz, a clock frequency to be used in the phase locked loop to center the oscillators

1. A method for providing clock signals to a mixed signal telecommunication chip having a communication signal in a communication signal band, said clock signals comprising a central clock frequency signal and sub-frequency signals which are multiples or divisions of said central clock frequency signal, wherein the central clock frequency signal is selected such that the central clock frequency signal and the sub-frequency signals are located outside the telecommunication signal band.

2. The method according to claim 1, where the telecommunication signal band is between 2,402 GHz and 2,480 GHz.

3. The method according to claim 1, where the central clock frequency is a multiple of 2.

4. The method according to claim 1 or 2, where the central clock frequency is in between 70 MHz and 90 MHz, preferably 64 MHz, 76 MHz or 80 MHz.

5. The method according to claim 1, wherein the central clock frequency is 64 MHz, the precision is 8 bit and the over-sampling factor is 32.

6. The method according to claim 1, the chip comprising functional circuit blocks, wherein the central-clock-frequency is supplied to the functional blocks by an on-chip oscillator (12)

7. A mixed signal telecommunication chip comprising as functional blocks a RF front end unit (2), an analog to digital converter (4), a digital to analog converter (6), a modulator/demodulator (8), a RF synthesizer (10) and an oscillator (12) for processing a communication signal in a communication signal band, wherein the functional blocks are fed by clock signals comprising a central clock frequency signal and sub-frequency signals which are multiples or divisions of said central clock frequency signal, and wherein the central clock frequency signal and the sub-frequency signals are located outside of the telecommunication signal band.

8. The chip according to claim 7, wherein the telecommunication signal band is between 2,402 GHz and 2,480 GHz.

9. The chip according to claim 7, wherein the central clock frequency is a multiple of 2.

10. The chip according to claim 7, wherein the central clock frequency is in between 70 MHz and 90 MHz, preferably 64 MHz, 76 MHz or 80 MHz.

11. The chip according to claim 7, wherein the central clock frequency is 64 MHz, the precision is 8 bit and the over-sampling factor is 32.

12. The chip according to claim 7, wherein the D/A converter is directly connected to the RF front end portion.

13. The chip according to claim 7, comprising an on-chip-oscillator supplying the central clock frequency to the functional blocks.

14. The chip according to claim 7, wherein the on-chip oscillator is connected to an external oscillator.

15. The chip according to claim 7, wherein the external oscillator is a crystall oscillator.
